(19) United States
(12) Patent Application Publication
(10) Pub. No.: US 2025/0118918 A1
(43) Pub. Date: Apr. 10, 2025

(54) Ball and socket electrical connector blocks

(71) Applicant: Daniel A. Eichenbaum, Pittsburgh, PA (US)

(72) Inventor: Daniel A. Eichenbaum, Pittsburgh, PA (US)

(21) Appl. No.: 18/983,776

(22) Filed: Dec. 17, 2024

Related U.S. Application Data
(63) Continuation-in-part of application No. 18/741,718, filed on Jun. 12, 2024.
Application No. 18/741,718 is a continuation-in-part of application No. 18/645,023, filed on Apr. 24, 2024, now abandoned.
Application No. 18/645,023 is a continuation-in-part of application No. 29/905,488, filed on Oct. 20, 2023.
Application No. 29/905,488 is a continuation-in-part of application No. 29/901,893, filed on Sep. 6, 2023.

(51) Int. Cl. H01R 13/11; F16C 11/06

(52) U.S. Cl. CPC H01R 13/11; F16C 11/06; H01R 2201/00

(57) ABSTRACT

An electrical connecting ball and socket block system in which two or more connecting blocks each include at one end a socket side for fitting on or about a ball end of an adjoining or neighboring connecting block with at least one electrical connecting wire extending through the body of said block and terminating in an electrical connection at either the ball or socket end. The block bodies themselves are radially symmetric.

### CROSS-REFERENCE TO RELATED APPLICATIONS

This application is a continuation-in-part of: U.S. Design patent application Ser. No. 29/901,893, filed on Sep. 6, 2023, U.S. Design patent application Ser. No. 29/905,488, filed on Oct. 20, 2023, U.S. Utility patent application Ser. No. 18/645,023, filed on Apr. 24, 2024 and U.S. Utility patent application Ser. No. 18/741,718, filed on Jun. 12, 2024 all disclosures of which are fully incorporated by reference herein.

### BACKGROUND OF THE INVENTION

(1) Field of the Invention—The present invention relates to a set of interlocking or interconnecting blocks in varying shapes and sizes. Particularly, it relates to a set of radially symmetric blocks/block shapes that perform unique connecting means, more particularly electronic connecting means. With joinder of adjacent hinged end sections of two or more block shape elements, these systems allow for easier actuation to electronically connect and disconnect, adjoining blocks and making various electrical connector products therewith. Representative products include, but are not limited to, desk and nightstand lamps, and microphone stands. Still other uses of electrical connectors—robotic attachments (appendages, sensors, graspers, tools, docking port for multiple robots), home and vehicle improvement (lights, security system, doors with integrated electronics such as cameras or electronic locks or motorized windows), speaker/camera/microphone/light mount to mount to wall or mount to another mobile object (example: mount a light, flash, or microphone to a camera), office computer system mount where signal/power is required (keyboard and/or mouse mount, computer tower mount, video/tv screen mount, phone charger/mount), structural building component (chains of blocks to form columns or ropes with adjustable support flex: connectors allow the components to talk to each other).

Toy building blocks are generally well known. Such building block sets are often an important part of a child's learning and development process. Conventional building block sets allow children to use their imagination to creatively build/assemble a generally limitless number of configurations and/or structures. Conventional toy building block sets may include a variety of differently sized and/or shaped blocks. Some block sets employ varying degrees of attraction and/or removal forces to attach or detach blocks from adjoining blocks. From earlier submissions, applicant is pursuing patent coverage, both utility and design, on numerous substantially planar AND radially symmetric block varieties. For this particular improvement, the focus is on a worthwhile, versatile electrical element to the latter block variety.

(2) Description of Related Art including information disclosed under 37 CFR 1.97 and 1.98.

Not Applicable.

### BRIEF SUMMARY OF THE INVENTION.

An electrical connecting ball and socket block system is disclosed in which two or more connecting blocks for use with the system each include at one end a socket side for fitting on or about a ball end of an adjoining or neighboring connecting block with at least one electrical connecting wire extending through the body of said block and terminating in an electrical connection at either the ball or socket end. The block bodies themselves are radially symmetric.

In a first version of connecting block, the central shaft element includes a channel having a wire with plug in terminal extending outwardly from the rounded ball end of a block, for connecting to the female electrical connection of an adjoining block. As shown, that would be at/in the innermost base of the apron end of the adjoining block for making a swivel electrical connection between blocks. Alternately, the protruding electrical terminal wire may extend from within the apron end, for connecting to a corresponding, complementary female electrical connection in the outermost curve end of an adjoining block.

With the foregoing system of blocks, “chains” of connectors can be joined to one another, in series, to make an electrical array that can incorporate an electrical device such as a light, microphone or other means at its furthest most tip/end.

The opening and closing of these ball and socket block ends, especially with electrical wiring extending therethrough, still allow for: 1) easy separation or connection of the ball-and-socket when the socket is hinged open; 2) the socket to retain the ball portion when closed; and 3) variable compression of the socket on the ball portion with variable compressive force: i.e., less compression allows the ball to be retained by the joint but still rotate/pivot within the socket while higher socket compression grips the ball firmly and restricts its movement.

### BRIEF DESCRIPTION OF THE SEVERAL VIEWS OF THE DRAWING(S)

The following summary of figures will be better understood when read in conjunction with the appended drawings in which:

FIG. 1 is a top view of one embodiment electrical connector block with a ball end cable laid on its side;

FIG. 2 is a top view of the same connector block from FIG. 1 looking down axially onto the ball end cable;

FIG. 3 is a top view of the reverse, apron end of the same connector block from FIGS. 1 and 2;

FIG. 4 is a top plan view of a second embodiment of electrical connector block with a cable extending outwardly from its apron end;

FIG. 5A is a cross-sectional view of the electrical connector block from FIG. 1;

FIG. 5B is a cross-sectional view of an alternate electrical connector block with representative actuators and pushrods included;

FIG. 6 is a side sectional view showing the apron end of a first block joined to the ball end of a second block with electrical connectors extending through both units;

FIG. 7 is a closeup sectional view of the plug and socket connections to the boxed two joined units from FIG. 6;

FIG. 8 is a perspective view of multiple electrical connector blocks joined together to make a segmented, bendable arm having a flashlight at one end; and

FIG. 9 is a perspective view of a pair of stacked electrical connector blocks with a microphone wired therethrough.

### DETAILED DESCRIPTION OF THE INVENTION

Certain terminology is used in the following description for convenience only and is not limiting. The words “right,” “left,” “upper,” and “lower” designate directions in the drawings to which reference is made. The words “first” and “second” designate an order or operations in the drawings to which reference is made, but do not limit these steps to the exact order described. The words “inwardly” and “outwardly” refer to directions toward and away from, respectively, the geometric center of the blocks and/or set and designated parts thereof. The term “multi-” is defined herein as “three or more.” Additionally, the terms “a,” “an” and “the,” as used in the specification, mean “at least one.” The terminology includes the words specifically mentioned above, derivatives thereof, and words of similar import.

In the accompanying FIG's, common elements are commonly numbered between embodiments/versions though sometimes in the next hundred series. For example, a female end may be numbered 20 in a first embodiment but 120 for a second embodiment, 220 for a third, and so on. Note, the commonality of component parts are also consistently numbered in the next hundred series even in not expressly spelled out hereinbelow.

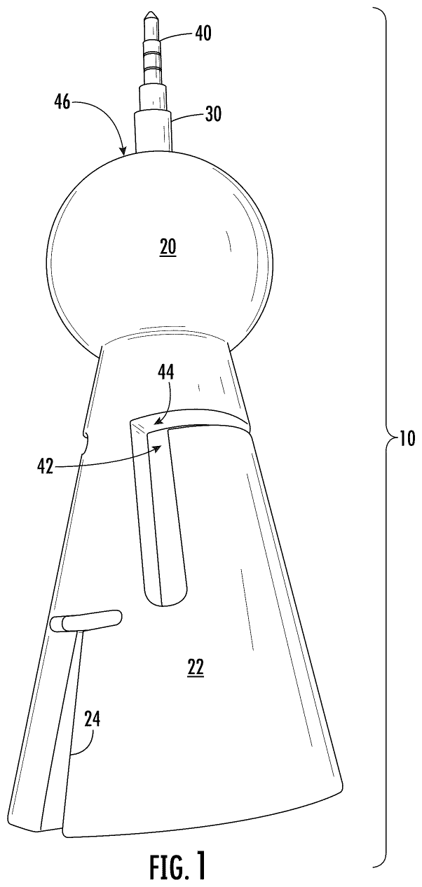

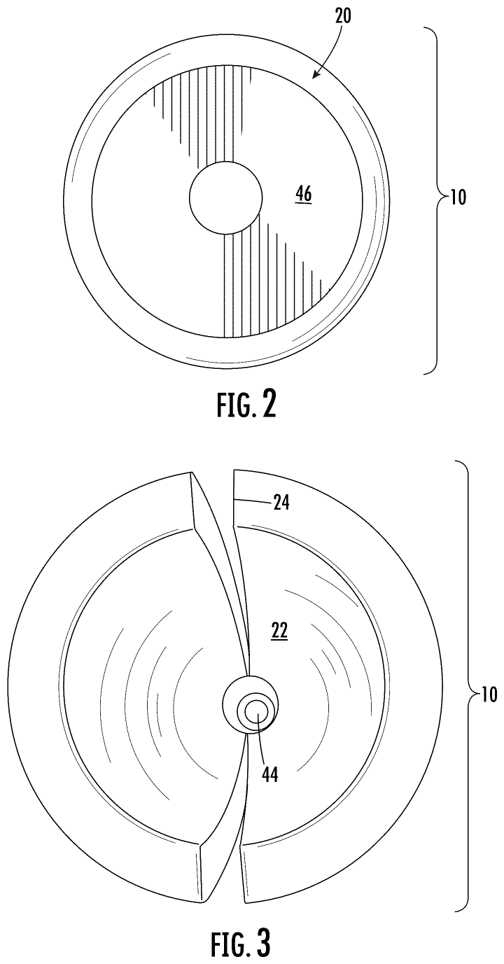

In FIGS. 1 through 3, there is shown a first version of three-dimensional building/connector block, generally 10, having a first mostly spherical or balled end 20 and a skirted or apron end 22 opposite the first balled end 20. The apron end 22 includes a splitter T groove 24 for some expandability/flexibility. An electrical cable, generally 30, extends through the main body of connector block 10. It starts at the male or tip end 40 and runs axially through the central block body 42 before terminating in the female connector end (or socket 44) into which an adjoining block's male/tip end would be inserted for making a viable electrical connection to same. This female socket 44 is better seen into the central most recess of apron end 22 in FIG. 3.

For representative purposes, the first embodiment of electrical block 10 is shown using a standard tip-ring-sleeve connector, also sometimes known as a mini jack or aux jack. It is to be understood that other interconnecting electrical cable ends may be substituted for same with other models of electrical blocks (or e-blocks). Other varieties may include connector sets for tip-ring-ring-sleeve, tip-ring-ring-ring-sleeve, RCA phono, barrel, coaxial, and other radially symmetric connectors.

On a preferred basis, the front of the ball portion of the ball-and-socket joint can be at least partially removed to leave a flat, open area 46 in which the electrical wire and sleeve can pass. Also, these blocks should have an axially centered shaft extending through them. That shaft should be slightly wider than the plug and socket connectors. The ends to these shafts should have a conical taper that is widest at the shaft entrance to the block. This permits extra wire/sleeve bending. The conical end opening, cone height, and angle relative to plane of the block may vary. The diagram conical openings are just one potential example. Simply stated: the conical openings and be shorter, taller, lead to a bigger opening, smaller opening, taper more abruptly or over a longer distance, etc.

The socket is affixed to the inside of the block with the socket facing the socket of the ball-and-socket joint. The plug protrudes from the front of the ball in the ball-and-socket joint. Preferably, it is connected to the socket with an electrical wire and supporting sleeve. The plug/sleeve/wire combination can be bent, but not compressed axially.

Each socket/wire/sleeve combination is connected together (or to one another). The plug connects to the electrical wire and socket only, though. The wire length is longer than the desired distance between the embedded socket and the socket in the adjoining block to allow for some change in relative distances between plug and socket as the neighboring ball-and-socket joint pivots about.

The sleeve is not axially compressible but rather a bendable tube, coil, or mesh that wraps around the electrical wire and plug. This sleeve should be firmly attached to the socket but not to the plug proper. The plug should be allowed to slide axially inside the sleeve just enough to provide strain-relief for the flexing electrical wire due to pivoting of the ball-and-socket joint.

As the ball-and-socket joint moves, the distance the electrical wire must traverse from the plug to its mated socket changes slightly. The sleeve, connected to the socket, allows the plug connector and the extra wire length inside of the sleeve to stretch out. The sleeve slides over the plug but the plug remains attached to the socket in the adjoining block.

When the ball-and-socket joints are being connected to one another, the plug enters the socket-end shaft of the ball-and-socket joint and is pushed inwardly to make a firm, complete connection with the socket. The sleeve has a ridge behind the bottom-most base of the connector that engages the connector to push it. The sleeve's non-compressibility permits a firm connection at the same time the ball-and-socket joint fully engages. The narrowness of the shaft confines the plug to prevent the wire from bending and ensure a connection to the adjoining block's socket.

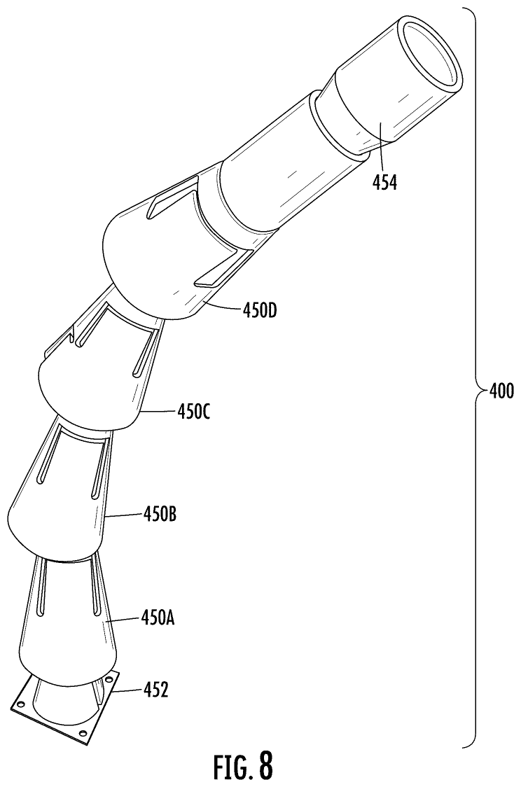

When the ball-and-socket joints are being disconnected from each other, the sleeve slides over the plug until teeth (or a ridge on the sleeve), item 360 in FIG. 7 grabs small ridges (item 362) on the plug connector or, in some plug designs, the top edge of the plug connector's base, to allow the sleeve to pull the connector from the socket. The electrical wire carries none of this pulling force.

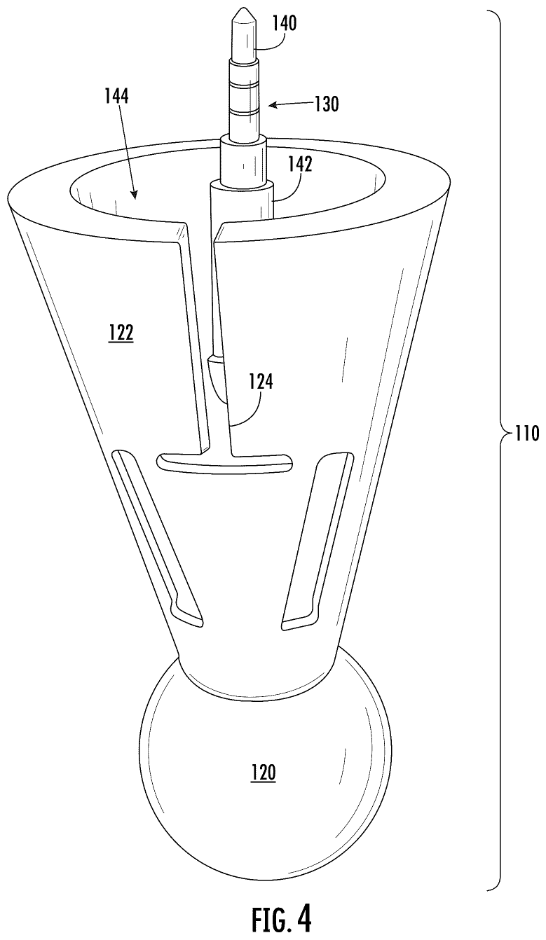

It should be noted that the above methodologies are reversible. In accompanying FIG. 4, a second version of three-dimensional building/connector block, generally 110, having a first mostly spherical or balled end 120 and a skirted or apron end 122 opposite the first balled end 120. Like for the first version, an electrical cable, generally 130, extends through the main body of connector block 110. But unlike the first version, this cable 130 does not start at the male or tip end 140 and axially through the central block body 142 from that block direction. Rather, cable 130 starts at the female connector end (or socket 144), within the apron end 122, before terminating at the spherical/balled end 120 for electrically connecting to an adjoining block's female/skirt or apron end.

These embodiments of electrical connector blocks are all radially symmetric—with a male balled end opposite a female skirted end. That gives the block proper somewhat of an A-shape cross-sectionally.

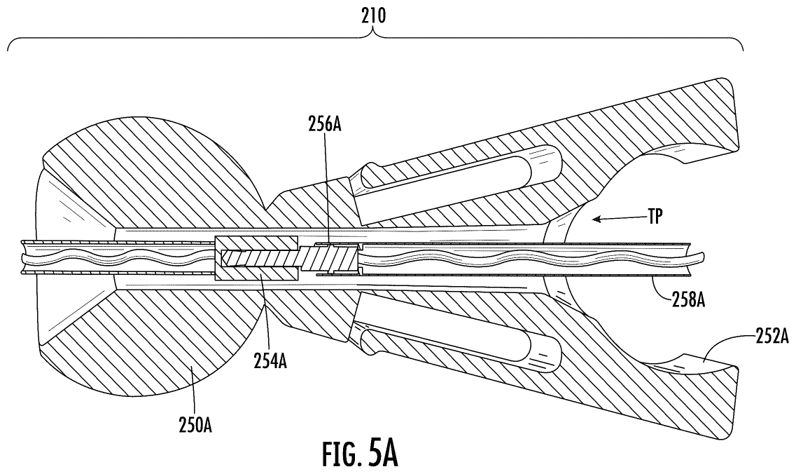

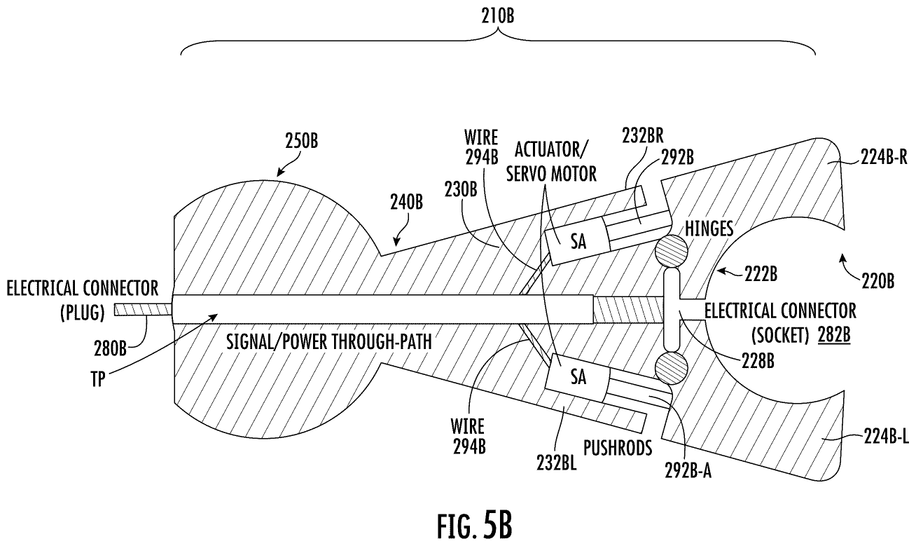

FIG. 5A shows a cross-sectional view of a connector 210A with a plurality of electrical connector components, i.e., a plug end 250A and separate socket end 252A, as well as at least one electrical socket 254A with its corresponding plug 256A. Wire (element 258A) connects the connector block through path TP to get its signal/power.

Embedded actuators inside the socket end of a ball-and-socket block connect to the main body to the hinged portion of the socket joint. Such actuator movements can translate into an opening and closing motion of the socket joint. The number of actuators needed per block will vary. Smaller blocks will likely have 1 or 2 such actuators with larger blocks having many more.

Devices with actuators can serve several purposes including: 1) replacing the need for direct human contact to open and close the socket, 2) providing the ability to remotely open and close the socket, 3) provide the ability to precisely vary the tension on the ball-and-socket joint. These actuator elements receive power and control signal through wiring in a central shaft that leads axially through the block. This allows chains of blocks to pass common power and signal cable(s) while still allowing the ball-and-socket joints to pivot/rotate without the cables impeding motion, particularly when multiple components of this invention are connected, block-to-block, in series.

FIG. 5B shows a cross-sectional view of a connector 210B with a plurality of electrical connector components, i.e., a plug end 280B and separate socket end 282B, as well as a plurality of servomotors or actuators SA with their respective pushrods 292B-A and 292B-B. A plurality of wires 294B connect actuators SA to the connector block's through path TP to get their signal/power. Such embedded actuators inside the socket end of a ball-and-socket block connect to the main body to the hinged portion of the socket joint. Such actuator movements can translate into an opening and closing motion of the socket joint. The number of actuators needed per block will vary. Smaller blocks will likely have 1 or 2 such actuators with larger blocks having many more.

Potential Rope/Cable and Architectural uses for the latter variations include extending an interconnected chain of such blocks to allow support columns or suspension cables with controllable rigidity. That, in turn, could allow future buildings to dampen sway from earthquakes or wind, and/or better absorb the motion of earthquakes or natural ground movement.

Furthermore, motors with drive wheels can be fitted to the spherical ends of these block variations to allow each block to independently position itself. The results could be buildings or building features that bend or twist on demand. Examples include: a skyscraper that twists to follow a sunset; or a building that can alter the curvature or position of its roof: (a) for decorative purposes; (b) to reduce wind forces; and/or (c) to block sunlight.

### Rope/Cable

Using one of the above computer-controlled, representative variable tension blocks, long “ropes” or “cables” of these blocks could be made and replace typical uses for a load-bearing rope or cable. These blocks could replace support cables on bridges and buildings with the added advantage of being able to control cable flexibility in real-time. Bridge sway can be minimized in such a scheme. Smaller, hand-held sized blocks could be used by people in place of a conventional rope but have the advantage of variable flexibility. With mechanized blocks of sufficiently small size (3 cm length or small) embedded in a fabric or flexible material, the blocks could allow the material to form a rigid shape or collapse/fold as needed. For example: one could conceivably make a cape that can transform from a rigid shape or collapse behind its wearer. There are also potential adjustable airfoil shape applications for aircraft and other vehicles.

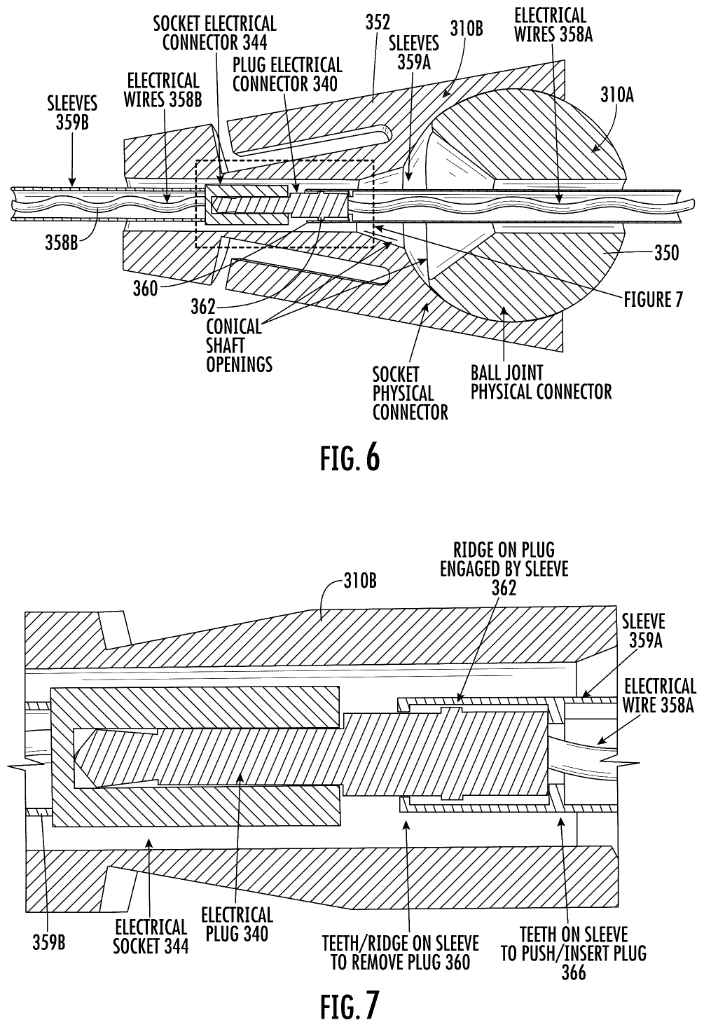

For FIGS. 6 and 7 (FIG. 7 being an enlarged view of the boxed region in FIG. 6), there is shown a full view of two blocks 310A and B joined together with a pair of connector wires 358A and B extending through the joined blocks, particularly through the ball end 350 of the right side block 310A, then the socket end 352 of the left side block 310B. The connector wires, as shown, extend inside their respective wire sleeves 359A and B. Optionally, the sleeve ends may include teeth 366 for assisting with the ability to push/insert plugs into one another. See especially, in FIG. 7, the ridge on plug engaged by teeth/ridge on sleeve.

For other components/applications, consider:
Electrical Connector Plug—The plug portion of a plug-and-connector electrical socket connector system.
Electrical Connector Socket—The socket portion of a plug-and-connector electrical socket connector system. The electrical socket is located inside the joint to allow the cable/sleeve combination to flex with the ball-and-socket joint.
Electrical Wires—Carry the electrical power and/or signal to and away from the plug and socket connectors.
Sleeve: A flexible tube or wrapping around the electrical cable that provides protection for the cable. It transfers the pushing and pulling force to the connector plug for plug insertion and removal and also helps protect the cable from between the ball and socket portions of the joint. The sleeve is flexible to allow bending but rigid axially to allow from grasping/pushing of the plug.
Teeth/Ridges: The sleeve has a series of ridges/teeth on the end of it and another set a short distance behind the plug. When the sleeve is pushed to make the plug connect with the socket, the plug slides backward in the sleeve until it meets the teeth positioned behind the plug. The teeth engage the back of the plug and push it to the socket. To disconnect the plug from the socket, the socket slides over the plug connector until teeth/ridges at the end of the sleeve engage a ridge on the plug, allowing the sleeve to pull the connector from the socket.
Conical Shaft Opening—the cone-shaped shaft opening that allows maximum flex of the sleeve/cable while guiding the wire/sleeve to the axial shaft.
Socket Joint Physical Connector—The socket portion of a ball-and-socket joint designed to physically connect and hold an object.
Ball Joint Physical Connector—The ball portion of a ball-and-socket joint designed to physically connect and hold an object.

It should be noted that this invention covers all four potential variations of connector blocks: plug end to plug end, plug end to socket end, socket end to plug end and socket end to socket end.

### Still Other AXIO Blocks Descriptions and Potential End Uses

### DESCRIPTION OF THE BLOCKS

Integrated tabs to release tension on the connectors allowing for easy block disconnection. Larger blocks may have an integrated motor and microcontroller to adjust connector tension.

Flat top and bottom of some of the blocks, along with pegs and holes, for easy and strong vertical and right-angle connections.

Ball-and-socket joints would allow for flexibility and rotational/movable connections.

### Power and Signal Transfer

A hollow shaft can be molded inside the AXIO block through which electrical cable or drive shaft with universal joints may be fitted. The electrical cable is fitted with plug and socket connectors to allow the cables to connect as separate AXIO blocks are joined together.

Examples of AXIO blocks holding a device and transporting signal/power to it: One could make connecting systems for audio/video recording and playback devices (such as cameras, video cameras, microphones, speakers), smartphones, and still other portable electronic devices. As seen in FIG. 8, there is shown a light stand 400 consisting of a plurality of interconnecting blocks 450A through D, extending upwardly from a flat central base 452 and terminating in a lighted end 454.

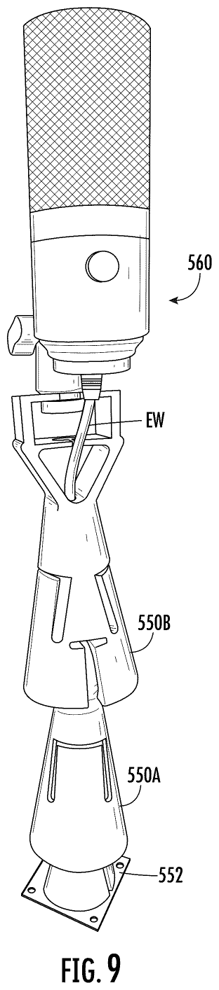

FIG. 9, described in more detail below, is one such representative sample of a microphone connection stand 500, comprised of interconnecting blocks 550A and B, from central base 552 and terminating in microphone 560 electrical wiring EW extending through the same. The microphone cable passing through can be made longer or shorter—with a little bit of cable—relief slack included therewith. Alternately, FIG. 9 could be modified to serve as a prototype camera mount (with a mounted camera in place of the microphone). Blocks of this size could hold larger audio/video equipment, such as televisions/monitors, computers, tablets.

### For Extra-Large Blocks (Over 100 cm in Length)

Building construction: Blocks can contain a motorized, semi-spherical connector to adjust tension on connected blocks. A microcontroller with X, Y, and Z axis positioning sensors in the AXIO block with either radio frequency or direct wired connection to a computer that would control each block in concert with the others. A chain of these blocks could allow support columns with controllable rigidity, allowing building to dampen sway from earthquakes or wind or better absorb the motion of earthquakes or natural ground movement. Motors with drive wheels can be fitted to the spherical end allowing each block to independently position itself. The results could be buildings or building features that bend or twist on demand.

Examples: A skyscraper twists to follow a sunset; or building that alters the curvature or position of its roof for decorative purposes or to reduce wind forces or block sunlight.

Still other applications include a rope or cable end uses: Using the above computer-controlled, variable tension blocks, long “ropes” or “cables” of these blocks could be made and replace typical uses for a load-bearing rope or cable. These blocks could replace support cables on bridges and buildings with the added advantage of being able to control cable tension in real-time. Bridge sway can be minimized in such a scheme. With mechanized blocks of sufficiently small size (3 cm length or small) embedded in a fabric or flexible material, the blocks could allow the material to form a rigid shape or collapse/fold as needed. Example: A cape that can transform from a rigid shape or collapse behind its wearer. Adjustable airfoil shapes for aircraft and other vehicles.

Examples include: individual, motorized AXIO blocks with integral positioning sensors can use their drive wheels to move toward each other and guide their ball ends into a matching socket end. The receiving socket end's motor will add tension force on the socket to connect the blocks together. The two blocks now can move together and pivot/rotate on their connected ball-and-socket joint. When multiple blocks are connected together by this technique, the blocks can pivot into different shapes by using the drive wheels in the connected joints and also move collectively by assembling articulated leg-like shapes or using their drive wheels.

Various models for both building blocks and connecting blocks (assemble-able into kits and larger shaped items) are envisioned. While some blocks may indicate size arrangements relative to one another and/or relative numbers of connecting means (whether protrusions/pegs or recesses for receiving the latter), it should be understood that such up's and down's are illustrative. In other words, a small I-block may have 2, 4 or more raised elements and its underside recesses for interlocking with one, OR MORE, adjacent blocks (of different varieties—arranged parallel with, perpendicular to or at a desired angle thereagainst. And the total sizes (lengths and widths) of respective blocks are also representative. In production, said PLUS (+) sign along with A, X, I, O and Y shapes may be longer, shorter, wider, etc. And the relative circumferences of the block end ball joints, and their corresponding socket apertures are also quite representative in relative scale.

It will further be appreciated that instead of a set number of partitions and equivalent shaped recessed areas, a greater number, possibly multiples of two or four partitions, might be provided, preferably also with similarly configured recessed areas, to increase the possible angle orientations available to transversely joined blocks. It will further be appreciated that instead of polynomial partitions and recessed areas, circular partitions and matching recessed areas may be provided with each divided into quadrants containing projections and depressions equivalent to those disclosed or suggest above.

Furthermore, other building set elements will be provided with the previously described engagements. The invention is not simply limited to rectangular polyhedron building blocks but further includes other building elements of other shapes and dimensions utilizing the above-described engagements. It is further understood that this invention should not be limited to the specific versions displayed, described and/or disclosed, but still cover modifications within the spirit and scope of the present invention.

Having described the best modes currently known for practicing this system and method, it is to be understood that the scope of this invention may be further described by the attached claims.

### SEQUENCE LISTING

Not applicable.

1. An electrically connecting ball and socket block system comprises:
(a) a plurality of ball and socket blocks, each ball and socket block being radially symmetric and including a rounded ball end and an apron end opposite the rounded ball end, said apron end adapted for receiving the ball end of an adjoining ball and socket block, each of said ball and socket blocks including a central channel through which an electrical connecting wire is installed; and
(b) the electrical connecting wire for installing in the central channel of the ball and socket block, said electrical connecting wire having a male connecting end and a female connecting end.

2. The electrically connecting ball and socket block system of claim 1 wherein the male connecting end of the electrical connecting wire protrudes outwardly beyond the ball end of the ball and socket block.

3. The electrically connecting ball and socket block system of claim 2 wherein a face of the ball end is at least partially flattened on at least one side.

4. The electrically connecting ball and socket block system of claim 3 wherein the face of the ball end is inwardly conical.

5. The electrically connecting ball and socket block system of claim 1 wherein the apron end of the ball and socket block includes at least one expansion joint extending upwardly from an interior point of the socket and allowing for lateral movement when the ball end of the adjoining block is inserted into the socket end and removed from the socket end.

6. The electrically connecting ball and socket block system of claim 5 wherein the socket end further includes a plurality of elongate clip arms which when squeezed towards one another assists with the insertion of the ball end of the adjoining block into the socket end and removal therefrom.

7. The electrically connecting ball and socket block system of claim 1 wherein the male connecting end of the electrical connecting wire protrudes outwardly beyond the apron end of the ball and socket block.

8. The electrically connecting ball and socket block system of claim 1 wherein each ball and socket block is made from injection molded or 3D printed plastic.

9. The electrically connecting ball and socket block system of claim 1 wherein each ball and socket block resembles a conically shaped A in cross-section.

10. The electrically connecting ball and socket block system of claim 1 wherein the electrical connecting wire is encased in a sleeve.

11. The electrically connecting ball and socket block system of claim 10 wherein the sleeve includes one or more teeth and ridge combinations.

12. The electrically connecting ball and socket block system of claim 1 wherein the male connecting end of the electrical connecting wire protrudes outwardly beyond the socket end of the ball and socket block.

13. The electrically connecting ball and socket block system of claim 1 wherein a plurality of ball and socket blocks can be joined together, in series, and electrically interconnected to form a consumer product selected from a desk lamp and a microphone stand.

14. An electrically connecting ball and socket block system comprises:
(a) a plurality of ball and socket blocks, each ball and socket block being radially symmetric and including a rounded ball end and an apron end opposite the rounded ball end, said apron end adapted for receiving the ball end of an adjoining ball and socket block, each of said ball and socket blocks including a central channel through which an electrical connecting wire is installed, the male connecting end of the electrical connecting wire protruding outwardly beyond the ball end of the ball and socket block; and
(b) the electrical connecting wire for installing in the central channel of the ball and socket block, said electrical connecting wire having a male connecting end and a female connecting end and extending within a pair of interlocking sleeves.

15. The electrically connecting ball and socket block system of claim 14 wherein the sleeve includes one or more teeth and ridge combinations.

16. The electrically connecting ball and socket block system of claim 14 wherein each ball and socket block is made from injection molded or 3D printed plastic.

17. The electrically connecting ball and socket block system of claim 14 wherein a plurality of ball and socket blocks can be joined together, in series, and electrically interconnected to form a consumer product selected from a desk lamp and a microphone stand.

18. A method for electrically connecting blocks comprising:
(a) providing a plurality of ball and socket blocks, each ball and socket block being radially symmetric and including a rounded ball end and an apron end opposite the rounded ball end, said apron end adapted for receiving the ball end of an adjoining ball and socket block, each of said ball and socket blocks including a central channel through which an electrical connecting wire is installed, each electrical connecting wire having a male connecting end and a female connecting end;
(b) bringing the male connecting end of a first ball and socket block near the female connecting end of a second ball and socket block; and
(c) pushing the first ball and socket block and the second ball and socket block together until the male connecting end and the female connecting end are joined to one another.

19. The method of claim 18 wherein the male connecting end and the female connecting end extend within a pair of interlocking sleeves.

20. The method of claim 18 wherein a plurality of ball and socket blocks are joined together, in series, and electrically interconnected to form a consumer product selected from a desk lamp and a microphone stand.
